(19) United States
(12) Patent Application Publication
(10) Pub. No.: US 2007/0072988 A1
(43) Pub. Date: Mar. 29, 2007

(54) Tricarboxylic acid ester plasticizers and methods of making

(75) Inventors: Edward P. Frappier, Kernersville, NC (US); Samuel W. Kennedy, Liberty, NC (US)

Correspondence Address: ICE MILLER LLP, ONE AMERICAN SQUARE, SUITE 3100, INDIANAPOLIS, IN, 46282-0200, US

(73) Assignee: Vertellus Performance Materials, Inc., Greensboro, NC (US)

(21) Appl. No.: 11/527,268

(22) Filed: Sep. 26, 2006

Related U.S. Application Data
(60) Provisional application No. 60/720,626, filed on Sep. 26, 2005.
(60) Provisional application No. 60/720,627, filed on Sep. 26, 2005.

(51) Int. Cl. C08F 214/06

(52) U.S. Cl. 524/567; 524/296

(57) ABSTRACT

A plasticizer formed by reacting a carboxylic acid with a mixture of two or more alcohols that vary from one another by the number of carbons comprising them. The carboxylic acid used may be a tricarboxylic acid such as citric acid or any other carboxylic acid. Further, the resultant ester formed by reacting the carboxylic acid with the alcohol mixture may be acylated to form a plasticizer having somewhat different characteristics. According to the present invention, a plasticizer formed by any of the processes described herein can be used in conjunction with polymers according to methods well known in the art to increase pliability and plasticity.

### CLAIM OF PRIORITY

The present application claims priority to U.S. Provisional Application Ser. Nos. 60/720,626 for Citrate Acid Ester Plasticizers and Method of Making and 60/720,627 for Trimellitic Acid Ester Plasticizers and Method of Making, filed Sep. 26, 2005.

### BACKGROUND

The present invention generally relates to the field of polymers. Specifically, the present invention relates to plasticizers used in polymers to create desired physical characteristics in the resulting polymer/plasticizer complex, such as increasing flexibility, pliability and plasticity in the resultant polymer complex. For example, plasticizers such as di(2-ethylhexyl)phthalate (“DEHP”), di-isononyl phthalate (“DINP”), and other phthalate plasticizers have long been industry standard plasticizers used with polymers such as homo- and copolymers—of polyvinyl chloride (“PVC”), polyvinyl dichlorides (“PVDC”), vinyls, and similar polymers and resins to impart pliability and plasticity while retaining good tensile strength, and resistance to cracking at low temperatures. For example, phthalate plasticizers have been used with rigid polymers such as PVC to create pliable materials used in such goods as intravenous (IV) bags and tubing, molded children's toys that require a soft or malleable feel, and various other applications where pliability or softness needs to be imparted to a polymer. Phthalate plasticizers such as DEHP and DINP were once preferred plasticizers due to their ability to impart the physical characteristics noted above, and their permanence in the polymer over time, even when exposed to relatively high temperatures and humidity.

However, public sentiment has prompted many manufacturers of consumer products to discontinue use of phthalates as a plasticizer due to concerns over potential adverse health effects. Thus, plasticizer compositions that reduce or eliminate phthalates, but perform similarly to DINP or other effective phthalate plasticizers, would be greatly appreciated in the art. Attempts have been made to supply a replacement for phthalate plasticizers, such as the use of acetyl tributyl citrate (“ATBC”), sold by Vertellus Performance Materials, Inc., of Greensboro, N.C. While ATBC has been found to be an effective substitute for phthalates such as DINP, improved permanence in polymers such as vinyls, PVCs, and PVDCs is desired. It is believed that permanence may be improved by replacing the low molecular weight butyl citrate ester chains with longer chain substituents. However, tests using long chain citrate esters such as acetyl trioctyl citrate and acetyl tridecal citrate have shown these long chain citrate esters to be poorly compatible or incompatible with many polymers, especially when used in the concentrations required for rotational molding of products such as children's toys, or in the production of polymer sheeting or films such as those used in the production of bags for administering intravenous pharmaceuticals. Thus, simply increasing the chain length of substituents has not proven to be a viable option for increasing permanence in a non-phthalate plasticizer, as in many plastisols.

Other attempts to increase permanence in non-phthalate plasticizers include the creation of mixed species of citrate esters formed by reacting commercially available side streams of mixed longer chain alcohols (specifically mixtures of hexanol, octanol, and decanol, and mixtures of octanol and decanol) with citric acids, and thereafter acetylating the resultant ester. Unfortunately, these mixed species of esters have also shown poor compatibility with some polymers, particularly when the plasticizer is used at a level above 20% of the resultant polymer/plasticizer.

Therefore, alternative non-phthalate plasticizers, which show an improved permanence in, and high compatibility with, a broad range of polymers would be greatly appreciated in the art.

### SUMMARY

The present invention relates to plasticizer systems, their method of making, and use thereof. According to one aspect of the present invention, a novel plasticizer may be formed by reacting at least two different alcohols with a tricarboxylic acid. In one embodiment, the two alcohols vary from one another in their carbon content by at least four carbons. In another embodiment of the present invention, the tricarboxylic acid selected is citric acid. Further, it should be noted that optionally the citrate esters formed by the method discussed above may be acylated to create plasticizers with slightly different properties.

For clarity, it will be appreciated that the selection of two alcohols used in the present invention may be selected by expressing the number of carbons in the first alcohol as m, and the number of carbons in the second alcohol as n, wherein m−n>4. Further, according to one aspect of the present invention, the alcohols selected might be limited to the number of atoms by defining n as an integer greater than 0 and less than 13.

According to another embodiment of the present invention, a plasticizer formed according to the methods detailed above may be used to form a plasticized polymer by adding any plasticizer formed by the method or combination of methods outlined above and combining the plasticizer with a selected polymer to form a mixture. Optionally, the mixture may be such that the plasticizer comprises at least 15% plasticizer by weight.

### DESCRIPTION

The present invention relates to compositions of plasticizers used to produce plastics having desired flexibility, pliability and plasticity, a method for making the plasticizers, and a method for using the plasticizers.

The polymer industry has been searching for an alternative to phthalate based plasticizers such as the previous industry standard DINP. However, creating a non-phthalate plasticizer with similar physical properties such as pliability or efficiency (measured in Shore A Hardness) imparted to the polymer, low temperature crack resistance, tensile strength, tensile elongation, retention or permanence of the plasticizer in the polymer mixture over time, and resistance to water and high humidity has proven difficult. The present invention presents novel compositions that meet some or all of these properties.

In particular, the present composition relates to plasticizer systems that are tailored to meet particular requirements, illustratively having a high compatibility with the polymers to which it is applied, and displaying an effective permanence in the polymer mixtures comprising the plasticizer. For example, one illustrative embodiment of the present invention relates a plasticizer that displays plasticizing qualities comparable to that of DINP, although that plasticizer does not comprise phthalate. Illustratively the plasticizer displays a permanence of no more than 30% loss of the plasticizer from the plasticizer/polymer mixture over a 28 day period when exposed to a temperature of 70 degrees Celsius. More illustratively, the permanence displays no more than 25% loss of the plasticizer in the 28 day period, and exemplary about 18% loss.

Specifically, one embodiment of the present invention relates to a plasticizer formed by the reaction of at least two different alcohols with a carboxylic acid (e.g., a tricarboxylic acid such as citric acid, aconitic acid) or its anhydride. Illustratively, the alcohol species vary in the number of carbon atoms comprising them by more than four carbon atoms (e.g., butanol and nonanol, which vary by five carbon atoms). In another other embodiment, the resultant esters formed above are then acetylated by a method well known in the art, such as adding acetic anhydride to the esters, thereby forming an acetylated ester.

### EXAMPLE I

In one exemplary embodiment, not intended to limit the embodiments discussed above, citric acid is reacted with equimolar portions of n-butanol and isononyl alcohol. Thus, for example, two moles (2M) of citric acid may be reacted with three moles (3M) of n-butanol and three moles (3M) of isononyl alcohol to form two moles (2M) of a plasticizer according to the present invention. It will be appreciated that various mixtures of the molar ratios of the alcohol will result in a different proportions of the mixed ester. For example, in alternate embodiments, when 1M of the tricarboxylic acid used, the alcohols used in the reaction are added in a molar ratio such that they are combined to form 3M of alcohol. For example, if 1.25 M of N-Butanol is used, 1.75 M of second alcohol (said second alcohol having more than 4 carbons than butanol e.g. octanol, nonanol, decanol, etc.) is use. Alternatively, if 1.5 M butanol is used, 1.5 M of the second alcohol is used; if 1.6 M of butanol is used, 1.4 M of the second alcohol is used; if 1.75 M of butanol is used, 1.25 M of the second alcohol is used; if 2.0 M of butanol is used, 1.0 M of the second alcohol is used; if 2.2 M of butanol is used, 0.8 M of the second alcohol is used; if 2.4 M of butanol is used, 0.6 M of the second alcohol is used; if 2.6 M of butanol is used, 0.4 M of the second alcohol is used; if 2.8 M of butanol is used, 0.2 M of the second alcohol is used. Likewise, as discussed above, any ratio of the two selected alcohols may be used, with the preferred overall molar ratio of tricarboxylic acid to the combined alcohols is approximately 1:3. Optionally, the resultant plasticizer is then acetylated by means well known in the art (e.g., reaction of the plasticizer with acetic anhydride). The resultant plasticizer is a mixture of several species of acetyl tricarboxylic citrates. In the above example utilizing N-Butanol and Isononyl alcohol, the plasticizer is a mixed ester comprising acetyl tri-n-butyl citrate, acetyl tri-isononyl citrate, acetyl di-n-butyl, monoisononyl citrate, and acetyl mono-n-butyl, di-isononyl citrate (collectively, the “Mixed Ester”).

As shown in table 1, the mixed ester formed in the above example has been shown to produce closer physical performance results to that of DINP than a single acetyl tricarboxylic acid ester (such as acetyl tri-n-butyl citrate) or a physical blend of two such acetyl tricarboxylic acid esters (such as a physical blend of acetyl tri-n-butyl citrate and acetyl tri-isononyl citrate). For example, as shown in Table I below, the mixed ester plasticizer displays a permanence in the polymer mixture that is nearly double that of other non-phthalate plasticizers without a loss of other desirable properties. Further, the plasticizer described in the example produces plasticized plastics that exhibit superior resistance to water and humidity.

TABLE 1

| | | | | Mixed |
|---|---|---|---|---|
| | | | | Ester From |
| | | Acetyl | | Example |
| | | Tri-n-butyl | Physical | (n-butanol/ |
| Property/Plasticizer | DINP | Citrate | Blend** | isononyl alcohol) |
| Tensile Strength | 2157 | 2300 | 2267 | 2267 |
| (PSI) | | | | |
| Ultimate Elongation | 380% | 379% | 348% | 356% |
| (%) | | | | |
| Low Temperature | −64.5° | −57.5° | −49.5° | −59.5° |
| Cracking (° Celsius) | | | | |
| Permanence (% loss | 7.4% | 64.1% | 33.5% | 18.2% |
| of plasticizer in 28 | | | | |
| days at 70 Celsius) | | | | |

*All results tested at 40% plasticizer (by weight), used with PVC as the polymer (Geon 121A resin used in this example, available from PolyOne Corporation, Lemont, Illinois) and 3% stabilizer (Mark 3023 stabilizer used in this example, available from Chemtura, Germany).
**Acetyl Tri-n-butyl Citrate and Acetyl Tri-isononyl Citrate

Further, the mixed ester plasticizer formed by the process outlined above displays a compatibility with polymers that is not shown with the formation of a mixed ester plasticizer made by the mixture of commercially available mixed alcohols such as octanol and decanol (“C8-10”) or hexanol, octanol, and decanol (“C6-10”). Thus, selection of alcohols according to the present invention results in a plasticizer with better compatibility with polymers than previous plasticizers made using commercially available mixed alcohol streams. For example, one will appreciate that use of branched alcohols with a carbon chain larger than 8, such as isononal alcohol, isodecal alcohol may improve compatibility with long chain plastics such as PVC. Further, current testing indicates that permanence of the mixed ester according to the present application may show even better comparative permanence when compared over a longer period of time and under less extreme temperatures.

One of ordinary skill in the art will appreciate that tricarboxylic acids other than citric acid (such as aconitic or trimellitic acid) may be used to create a plasticizer system, and several combinations of alcohols may be used. For example, three alcohols, each varying from one another in their carbon content, may be combined with a tricarboxylic acid. In our example, the ratio of the three alcohols to one another varies, but the overall molar ratio of tricarboxylic acid to alcohol is about 1:3. Optionally, excess alcohol may be used to drive the reaction. Further, one of ordinary skill in the art will appreciate that at least two alcohols combined with a carboxylic acid need not be mixed in an equimolar ratio to one another. It is understood that varying the chain length of the alcohols and varying the ratio of alcohols to one another allows one to alter the resultant species in the plasticizer to obtain a desired property.

According to comparative studies with plasticizers created according to the present application as discussed above, Table 2 below summarizes the properties of a plasticizer according to the present application when comparing the acetylated form with the non-acetylated form. For comparison, acetyl tri-n-butyl citrate and DINP were also tested using similar percentages as disclosed below.

TABLE 2

| | | Acylated | | |
|---|---|---|---|---|
| | Non-Acylated | Mixed Ester | | |
| | Mixed Ester | From Example | | |
| | (n-butanol/ | (n-butanol/ | Acetyl | |
| | isononyl | isononyl | Tri-n-butyl | |
| | alcohol) | alcohol) | Citrate | DINP |
| Hardness, | 68.9 | 68.7 | 64.7 | 67.7 |
| 10 sec | | | | |
| Tensile | 1914 | 2154 | 2012 | 2056 |
| Strength, psi | | | | |
| Ultimate | 285 | 331 | 349 | 351 |
| Elongation, % | | | | |
| Brittle Point, | −59.3 | −62.3 | −53.5 | <68.5 |
| ° C. | | | | |
| Volatile Loss, | 7.69 | 7.33 | 8.01 | 6.40 |
| Air | | | | |
| Water Ext. | 2.28 | 1.62 | 1.53 | 1.26 |
| Soapy Water | 4.11 | 3.79 | 3.55 | 1.95 |
| Ext | | | | |
| Oil Ext | 52.73 | 41.46 | 42.43 | 42.94 |

* All results tested at 40% plasticizer (by weight), used with PVC as the polymer (Geon 121A resin used in this example, available from PolyOne Corporation, Lemont, Illinois) and 3% stabilizer (Mark 3023 stabilizer used in this example, available from Chemtura, Germany).

It will be appreciated that the water extract and soapy water extract of the acetylated mixed ester performed within a range comparable to DINP, while having the lowest brittle point and a low volatile loss in air. Further, the non-acetylated form performed in a usable range for possible applications.

Upon mixture of the components into a plastisol, the viscosity of the mixtures was measured at time 0 and time 24 as shown below for comparison in Table 3 below. It will be appreciated that the viscosity for both the acylated and non-acylated forms performed comparably to DINP, indicating its utility as a replacement therefore.

TABLE 3

| | | Acylated | | |
|---|---|---|---|---|
| | Non-Acylated | Mixed Ester | | |
| | Mixed Ester | From Example | | |
| | (n-butanol/ | (n-butanol/ | Acetyl | |
| Viscosity | isononyl | isononyl | Tri-n-butyl | |
| at Time | alcohol) | alcohol) | Citrate | DINP |
| Time 0 | 2520 | 2448 | 2604 | 2112 |
| 24 Hours | 3048 | 2944 | 2880 | 3080 |

Table 4 below summarizes yet another embodiment of the present application wherein a plasticizer according to the present application is mixed with a PVC resin and a stabilizer. In the study summarized in Table 4, a Geon 110×500 PVC resin (available from PolyOne Corporation, Lemont, Ill.) was mixed at 65% by weight with 32% by weight of the disclosed plasticizers, and with 3% Synpron 1321 stabilizer. As shown below, both the acetylated and non-acetylated forms of the plasticizers performed within an similar range of DEHP, a plasticizer commonly used in pharmaceutical fluid bags such as blood bags or intravenous fluid bags and medical tubing, and performs as well as or better than some DEHP alternatives (such as n-Butyryltri-n-hexyl Citrate and Acetyl Tri-n-butyl Citrate) in certain applications. Further, as shown below, the plasticizers according to the present application further showed a good performance with regard to soapy water extract percentages, as a reasonable amount of withdrawal of the plasticizer into a blood bag extends the life of red blood cells contained in the bag.

TABLE 4

| | | Acylated | | | |
|---|---|---|---|---|---|
| | Non-Acylated | Mixed Ester | n- | | |
| | Mixed Ester | From Example | Butyryltri- | Acetyl | |
| | (n-butanol/ | (n-butanol/ | n-hexyl | Tri-n-butyl | |
| Property | isononyl alcohol) | isononyl alcohol) | Citrate | Citrate | DEHP |
| Hardness, Shore A, 10 sec | 82.6 | 80.8 | 80.8 | 78.5 | 77.7 |
| Tensile Strength, psi | 2587 | 3122 | 2767 | 2740 | 2684 |
| Ultimate Elongation, % | 226 | 306 | 331 | 284 | 300 |
| *Brittle Point, ° C. | −47.5 | −45.5 | −42.5 | −38.5 | −44.5 |
| Air Volatility, % pl loss | 1.28 | 1.22 | 0.50 | 2.10 | 0.85 |
| Water Ext, % pl loss | 0.51 | 0.27 | 0.19 | 0.34 | 0.01 |
| Soapy Water Ext, % pl loss | 1.84 | 1.30 | 0.45 | 1.53 | 0.49 |
| Oil Ext, % pl loss | 29.5 | 17.0 | 22.2 | 21.4 | 18.9 |

In addition, the non-acylated mixed ester using butanol and nonanol has been shown to have a fusion time of 2 minutes, 22 seconds when using a Brabender PL-2100 and 60 mL bowl to mix the components. This is in comparison to a time of 1 minute, 37seconds for n-butyryltri-n-hexyl citrate, 25.3 second for acetyl tri-n-butyl citrate, and 36.7 seconds for DEHP. However, the acylated mixed ester according to the present application has been shown to have a fusion time of 34 seconds, which is even faster than the previous industry standard plasticizer.

### EXAMPLE II

According to another embodiment of the present invention, a plasticizer formed by any of the methods described above is added to a polymer to increase pliability and plasticity in the polymer. For example, a plasticizer formed according to any of the methods above is used as a replacement to a phthalate plasticizers. In one exemplary embodiment, a plasticizer formed according to any of the methods above may be added to a polymer to form a mixture of approximately 15%-20% by weight plasticizer and a majority of the remainder of the mixture comprising one or more polymers or resins by weight to form a polymer mixture suitable for injection molding. The method of combining said plasticizer and the polymers and resins may be achieved by any one of the many methods well known in the art.

For example, illustratively, a mixture of 15%-20% by weight plasticizer with the balance comprising one or more polymers or resins such as homo- or copolymer-PVC, PVDC, or vinyl may be used in injection molding processes to produce children's toys.

### EXAMPLE III

According to another embodiment of the present invention a plasticizer as described above may be added to a polymer to form a mixture of at least 20% by weight plasticizer (illustratively 20% to 50% by weight) with a majority of the remainder of the mixture comprising one or more polymers (illustratively PVC, PVDC, or vinyls) or resins by weight to form a polymer mixture suitable for rotational molding or preparation of sheet or film materials. The method of combining said plasticizer and the polymers and resins may be achieved by any one of the many methods well known in the art, and may be used to create, for example, intravenous (IV) pharmaceutical bags or rotationally molded toys such as a doll head.

In fact, at least one citrate ester formed according to the method described above has shown notable compatibility with polymers, when compared to other non-phthalate plasticizers. The compatibility of the plasticizer systems compositions described herein have thus allowed the plasticizers to be used in greater percentages by weight in polymer mixtures, allowing the use of non-phthalate plasticizers in capacities where previous non-phthalate plasticizers had proven unworkable.

Although the present invention has been described in considerable detail with reference to certain preferred versions thereof, other versions are possible. For example, one of ordinary skill in the art will appreciate that different carboxylic acids (including dicarboxylic acids and other molecules containing multiple carboxylic acid groups) may be used to form plasticizers according to the present invention. Further, alcohols may be selected which have four or more carbon variances between them. Additionally, the use of the resultant plasticizers may be used in many other polymer applications. Therefore, the spirit and scope of the appended claims should not be limited to the description of the preferred versions contained herein.

What is claimed is:

1. A method of producing a plasticizer composition comprising the steps of:
a. providing an alcohol mixture comprising a first alcohol having m carbons with a second alcohol having n carbons, wherein m>n;
b. reacting the alcohol mixture with a tricarboxylic acid to form an ester.

2. A plasticizer formed by the method of claim 1.

3. The method of claim 1, further comprising the step of acylating the ester.

4. The method of claim 1, wherein m−n>4

5. The method of claim 3, wherein n is an integer between 0 and 13.

6. The method of claim 4, wherein n<6 and m>8.

7. The method of claim 1, wherein the second alcohol is butanol and the first alcohol is nonanol.

8. The method of claim 1 wherein the first alcohol is a branched alcohol.

9. The method of claim 8 wherein the tricarboxylic acid is citric acid.

10. The method of claim 1, wherein the alcohol mixture consists essentially of the first alcohol and the second alcohol.

11. The method of claim 1, wherein the first and second alcohols are combined in equimolar amounts.

12. The method of claim 1, wherein a ratio of alcohol mixture to tricarboxylic acid is three moles to one mole, respectively.

13. The method of claim 1, wherein the tricarboxylic acid is selected from the group comprising citric acid, trimellitic acid, and aconitic acid.

14. The method of claim 1, wherein the tricarboxylic acid is in its anhydrous form.

15. The method of claim 1, wherein the plasticizer composition comprises a plurality of resultant ester species.

16. The method of claim 1, wherein:
a. the first alcohol is isononyl alcohol,
b. the second alcohol is butyl alcohol, and
c. the tricarboxylic acid is citric acid,
d. wherein the alcohol mixture consists essentially of isononyl alcohol and butyl alcohol in about equimolar amounts, and
e. wherein the plasticizer composition comprises a plurality of different ester species.

17. The method of claim 16 wherein the ester or ester species comprises at least one moiety of the first alcohol and at least one moiety of the second alcohol.

18. A composition produced by the method of claim 16.

19. A method of forming a plasticized polymer comprising the steps of:
a. providing an alcohol mixture comprising a first alcohol having m carbons with a second alcohol having n carbons, wherein m>n;
b. reacting the alcohol mixture with a tricarboxylic acid to form an ester;
c. selecting a polymer; and
d. combining the plasticizer with the polymer to form a mixture.

20. The method of claim 20, wherein the plasticizer comprises at least 15% by weight of the mixture.

21. The method of claim 21, comprising the additional step of heating the mixture.

22. The method of claim 21, wherein the polymer is PVC, PVDC, or vinyl.

23. A composition according to the method of claim 23, wherein the plasticizer displays a permanence in the range of about 13% weight loss to about 35% weight loss.
